(19) United States
(12) Patent Application Publication
(10) Pub. No.: US 2020/0111046 A1
(43) Pub. Date: Apr. 9, 2020

(54) AUTOMATED AND INTELLIGENT TIME REALLOCATION FOR AGENDA ITEMS

(71) Applicant: CA, Inc., New York City, NY (US)

(72) Inventors: Michael Ball-Marian, Erie, CO (US); Richard Michael Lansky, Boulder, CO (US)

(21) Appl. No.: 16/154,402

(22) Filed: Oct. 8, 2018

(51) Int. Cl. G06Q 10/06; G06F 15/18

(52) U.S. Cl. CPC G06Q 10/063114; G06Q 10/06316; G06F 15/18; G06Q 10/0633; G06Q 10/063116

(57) ABSTRACT

One or more identifiers associated with one or more topics that are scheduled to be addressed within an event are identified. A first time duration allocated for addressing a first topic of the one or more topics is identified. The event is monitored to determine whether the first topic has been addressed outside of a threshold of the first time duration. A second time associated with the event is modified based at least in part on the determining that the first topic has been addressed outside of the threshold.

### BACKGROUND

An event (e.g., a meeting, a conference, a workshop, etc.) typically includes an agenda of various topics or tasks that are scheduled to be completed during the event. In some instances, a fixed amount of time can be allocated for the topics or tasks. Typical software technologies for event planning may involve functionalities or tools that are configured to receive manual user input in order to facilitate particular event features, such as naming a title of a meeting.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

Embodiments of the technology described herein are directed to a computer-implemented method, a system, and a computer program product. In some embodiments, the computer-implemented method includes the following operations. A first request to generate an application workflow corresponding to a meeting is received. The application workflow includes a plurality of identifiers associated with a plurality of tasks that are candidate tasks to be completed during the meeting. User selections of a first identifier and a second identifier of the plurality of identifiers are received. The user selections are indicative of selecting a first task and a second task of the plurality of tasks that the meeting will include. A first time allocated for the first task to be completed by is identified. A second time allocated for the second task to be completed by is also identified. A third time allocated for the meeting to be completed by is further identified. It is determined that the first task has been completed outside of a time threshold associated with the first time allocated for the first task to be completed by. Based at least in part on the determining that the first task has been completed outside of the time threshold, the second time allocated for the second task is automatically changed to a fourth time allocated for the second task to be completed by.

In some embodiments the system includes at least one computing device having at least one processor and at least one computer readable storage medium having program instructions embodied therewith. In particular embodiments, the program instructions are readable or executable by the processor to cause the system to perform the following operations. A plurality of identifiers associated with a plurality of topics that are scheduled to be addressed are identified. A first time duration allocated for addressing a first topic of the plurality of topics to be addressed within is identified. It is determined whether the first topic has been addressed outside of a threshold associated with the first time duration. In response to the determining that the first topic has been addressed outside of the threshold, at least a second time duration allocated for at least a second topic of the plurality of topics is changed.

In some embodiments, the computer program product includes a computer readable storage medium having program instructions embodied therewith. In some embodiments, the program instructions are readable or executable by at least one processor to cause the at least one processor to perform the following operations. One or more identifiers associated with one or more topics that are scheduled to be addressed within an event are identified. A first time duration allocated for addressing a first topic of the one or more topics is identified. The event is monitored to determine whether the first topic has been addressed outside of a threshold of the first time duration. A second time associated with the event is modified based at least in part on the determining that the first topic has been addressed outside of the threshold.

### BRIEF DESCRIPTION OF THE DRAWINGS

Aspects of the technology presented herein are described in detail below with reference to the attached drawing figures, wherein:

FIG. 1 is a block diagram of a system in which particular aspects of the present disclosure are implemented in, according to certain embodiments.

FIG. 2 is a screenshot of an example graphical user interface, according to certain embodiments.

FIG. 3 is a screenshot of an example graphical user interface, according to certain embodiments.

FIG. 4 is a screenshot of an example graphical user interface, according to certain embodiments.

FIG. 5 is a flow diagram of an example process for automatically changing at least a second time allocated for a second task, according to certain embodiments.

FIG. 6 is a flow diagram of an example process for changing a time duration for a topic of one or more topics, according to certain embodiments.

FIG. 7 is a block diagram of a computing environment in which aspects of the present disclosure are employed in, according to certain embodiments.

FIG. 8 is a schematic diagram of a computing environment in which aspects of the present disclosure are employed in, according to certain embodiments.

FIG. 9 is a block diagram of a computing device, according to certain embodiments.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter also might be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

Existing software technologies have various shortcomings. For example, various event and agenda planning software technologies only compute data in response to manual user input, such as user preferences for meeting topics, desired time allocation, event notes, etc. In an illustrative example, some software technologies display an identifier that prompts a user to input the title of the meeting or other details into a field each time a user generates an event. In response to the user inputting these details into the field, these technologies can display the details so that the participants in the meeting can see data, such as the title of a meeting. However, continuous manual input of this information is time consuming, tedious, and may disrupt the flow of an event. One or more persons may allocate a fixed quantity of time among a fixed set of topics for an event. However, as soon as a particular topic is discussed for a longer time period than desired (or finishes early) according to the fixed quantity of time, the agenda of the event becomes inaccurate. Various existing technologies provide no way for generating or modifying time allocation for particular tasks or topics when a topic or task takes longer or shorter than expected. Accordingly, users have to manually take note of the changes. This may result in insufficient time to discuss all of the tasks or topics in an event, as the probability of making mistakes may be relatively high when users have to manually take note of these changes. Further, this can result in error prone or static hardware or software-based counters or timers, as they are not configured to automatically adapt (e.g., in near real-time) to these changes or other rules.

Some existing software technologies also have shortcomings in that they continually prompt users to input the same information regardless of what past user behavior, selections, or information have been received as input. Accordingly, these technologies may output the same displayed information or require users to input the same information every time they initiate a web-based session to generate a meeting, for example. In an example illustration, the same group of users may always attend the same meeting at the same time. However, existing software technologies may indefinitely, for each session, require a user to input the names of meeting participants, the time of the meeting, and the name of the meeting. This wastes time and can disrupt the flow of the meeting. Further, this can increase storage device I/O (e.g., excess physical read/write head movements on non-volatile disk) because each time a user inputs unnecessary and redundant information, the computing system often has to repetitively reach out to the storage device to perform a read or write operation, which is time consuming, error prone, and can eventually wear on components, such as a read/write head.

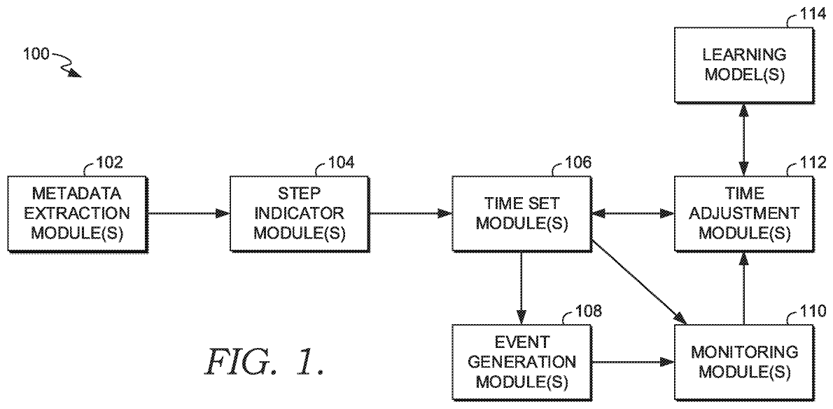

Various embodiments of the present disclosure improve these existing software technologies via new functionalities that these existing technologies or computing devices do not now employ. Further, various embodiments improve various computing structures (e.g., timer counters) and other computer operations (e.g., disk 110). For example, some embodiments improve existing software technologies by automating tasks (e.g., time reallocation) via certain rules. As described above, such tasks are not automated in various existing technologies and have only been historically performed by humans or manual input of users. In particular embodiments, incorporating these certain rules improve existing technological processes by allowing the automation of these certain tasks, which is described in more detail below. These rules may allow for improved counters or timer logic in order to automate time reallocation among topics or tasks. Particular embodiments also improve these existing software technologies by learning (e.g., via machine learning models) past user behavior, such as selections and input, in order to generate and compute certain data, such as modifying or reallocating time associated with an event. In this way, users do not have to keep manually entering the same information for each event they generate. Accordingly, because users do not have to keep manually entering the same information, storage device I/O is reduced. For example, a read/write head in various embodiments reduces the quantity of times it has to write data to a storage device, which may reduce the likelihood of write errors and breakage of the read/write head. Some embodiments also improve these existing software technologies by some or each of the processes, as described below with reference to FIGS. 1-9 of the present disclosure.

FIG. 1 is a block diagram of a system 100 in which particular aspects of the present disclosure are implemented in, according to certain embodiments. Although FIG. 1 describes particular modules representing specific components, it is to be understood that in some embodiments, more or less components may be illustrated and one or more of the modules may be combined to a single module. For example, in some embodiments, the time set module(s) 106 and time adjustment module(s) 112 is combined into a single module. In another example, the system 100 does not include the one or more learning model(s) 114. It is also understood that some or each of the modules represented in FIG. 1 may be included in the same physical host computing device or some or each of these modules may be distributed among various host computing devices, such as being distributed within a cloud computing environment for example. A cloud computing environment includes a network-based, distributed/data processing system that provides one or more cloud computing services. Further, a cloud computing environment can include many computers, hundreds or thousands of them or more, disposed within one or more data centers and configured to share resources over one or more networks.

The system 100 includes one or more metadata extraction modules 102, one or more step indicator modules 104, one or more time set modules 106 (e.g., counter or timer logic), one or more event generation modules 108, one or more monitoring modules 110, one or more time adjustment modules 112, and one or more learning models 114. The metadata extraction module(s) 102 extract metadata from a set of data. For example, in response to a user indicating that the user will generate an event, this module 102 may cause display of a window, notification, and/or user interface, which prompts a user to input the title of the event, the purpose of the event, the number of votes per attendee that will be allotted per attendee at a meeting, etc. Various other metadata may be extracted, such as a quantity of people that will attend or otherwise be associated with the event, location of the event, whether the event will be virtual or in-person, etc.

The one or more step indicator modules 104 in particular embodiments cause a notification, prompt, and/or user interface to be provided, which allows users to input or select particular topics or tasks (also herein referred to as “steps”) that the event will include. For example, in response to a user selection of a graphical user interface (GUI) button, the step indicator module(s) 104 may cause display of a plurality of fields that allow the user to select which predefined tasks the user will engage in for a particular meeting. In some embodiments, however, the tasks are not predefined tasks. Accordingly, the user may manually input the particular tasks or topics that the event will include.

The one or more time set modules 106 in some embodiments set the time (e.g., a clock time) or duration (e.g., a time range of beginning and end time) allocated for an event and each individual task or topic selected by the user. For example, the one or more time set modules 106 may receive input indicating that a meeting is set for a duration of 60 minutes, and the three tasks of the meeting—voting, discussion of first topic, and discussion of second topic—are each allotted 20 minutes. The one or more time set modules 106 may include or otherwise be associated with a logical counter, such that it is configured to count or calculate the quantity of time that goes by in response to an input. In some embodiments, the time set module(s) 106 set the time or duration in response to user selections or input. Alternatively or additionally, however, the time set module(s) 106 may set time based on one or more automated rules or in response to communication with other modules, such as the time adjustment module(S) 112.

In some embodiments, in response the metadata extraction module(s) 102 extracting data, the step indicator module(s) 104 performing functionality in order to specify tasks or topics, and the time set module(s) 106 setting time associated with an event and topics or tasks associated with the event, the event generation module(s) 108 may generate a logical event, which may be associated with initiating a counter or clock of the time set module(s) 106. For example, the event generation module(s) 108 may be associated with a GUI button that, when selected, both cause the time set module(s) 106 to initiate counting of time and provide a graphical user interface to be displayed. In an illustrative example, a button may be selected, which initiates a meeting among a group of people. In some embodiments, however, a meeting or other event may have already been started but may have been halted for a particular reason. According, a timer or counter associated with the time set module(s) 106 may have been paused. Accordingly, in some embodiments, a user may initiate a session a second time to resume the meeting. In these embodiments, an event generation module 108 does not generate the meeting. Rather, the monitoring of the meeting continues, via the one or more monitoring modules 110.

The one or more monitoring modules 110 monitor the time that each task or topic and event takes and notifies the time adjustment module(s) 112 in response to one or more rules being met or one or more times falling outside of a threshold. For example, using the illustration above, if the tasks assigned to a meeting were assigned 20 minutes each, and in response to the first task going over the 20 minute time allocation, the monitoring module(s) 110 may notify the time adjustment module(s) 112. The monitoring module(s) 110 may be configured to report or call the time adjustment module(s) 112 every particular Nth quantity of time after a first threshold has been met. For example, after a first task has gone over a 20 minute threshold (the time initially allocated for the first task to take), the monitoring module(s) 110 may notify the time adjustment module(s) 112 every 1 second, 5 seconds, 10 seconds, etc. thereafter in order to update the time adjustment module(s) 112 on the quantity of time that the first task is taking to be completed.

The time adjustment module(s) 112 in various embodiments is responsible for adjusting times scheduled for tasks or topics based on one or more other tasks or topics being discussed or addressed outside of a threshold (e.g., before or after the time allocated for particular tasks/topics set by the time set module(s) 106). For example, after a group in a meeting discusses a first of three tasks over the initial allotted time for the first task, the time adjustment module(s) 112 may adjust the time remaining on the second and third tasks. In various embodiments, the one or more time adjustment modules 112 include or otherwise are associated with a set of rules (e.g., conditional logic statements) that specify the specific quantity of time remaining topics or tasks will be allotted when a threshold has been met. These rules may allow the automation of time reallocation among tasks or topics (e.g., via novel counter or timer logic), which improve existing technologies as described above.

In some embodiments, the reallocation or adjusting of time of the remaining tasks or topics is based on how many steps are left in an event, how long each of the remaining steps were initially allocated (e.g., as set by the time set module(s) 106), and/or the total time an event has been allocated for. Accordingly, in these embodiments, time is not merely equally split among each remaining topic or task when another topic or task has been discussed outside of a time threshold. In some embodiments, a greater (or lesser) proportion of time is re-allocated to tasks or topics that are set to take longer than other tasks topics. In an example illustration of these embodiments, a meeting, which is set to take 1 hour and 40 minutes may include 4 tasks that need to be completed. The first task may be allocated to take 5 minutes, the second task 5 minutes, the third task 1 hour, and the fourth task 30 minutes. The first task may have taken 8 minutes. Accordingly, the one or more time adjustment modules 112 may need to reallocate or remove 3 minutes from an initial time allocation (e.g., as set by the time set module(s) 106) of one or more of the other tasks. In these embodiments, the time adjustment module(s) 112 may first identify that there are 3 tasks or steps left in the meeting. The time adjustment module(s) 112 may then identify the percentage that each remaining topic is schedule to take up in the meeting and responsively adjust the times based at least on the percentage. Each percentage may be identified by dividing the initial time allocation set for a given task by the overall event time and then reallocating time exactly according to the percentage. For example, if a meeting was running 10 minutes over and a first task time took up 50% of the total meeting time, a second task time took up 25% of the total meeting time, and a third task time took up another 25% of the total meeting time, the first task time may be reduced by 50% and the remaining task times may only be reduced by 25%, which matches their initial time allocations.

In some embodiments, the time adjustment module(s) 112 alternatively or additionally utilizes other rules than indicated above to adjust times initially allocated to topics or tasks. For example, in some embodiments, time is only adjusted for the next topic or tasks scheduled to be completed (and not the remaining topics) until only two topics or tasks remain, at which point it is determined which of the two tasks will be adjusted. In some embodiments, time adjustment is alternatively or additionally based on a ranking of topics. For example, a user may rank the importance of each topic and the time adjustment module(s) 112 may reallocate more time for higher ranked topics and less time for lower ranked topics, etc. Therefore, the adjustment module(s) 112 may score each topic (e.g., via integer-based scores) that reflect the ranking, and the reallocating of time for tasks or topics is directly proportional to the ranking of the topic or task in these embodiments.

In some embodiments, the time adjustment module(s) 112 alternatively or additionally utilize one or more learning models 114 to reallocate or adjust the time initially set by the time set module(s) 106. The one or more learning models 114 can be or include any suitable machine learning model. “Machine learning” as described herein, in particular embodiments, corresponds to algorithms that parse or extract features of historical data (e.g., a data store of historical meeting events), learn (e.g., via training) about the historical data by making observations or identifying patterns in data, and then receive a subsequent input (e.g., a current meeting event application workflow request) in order to make a determination, prediction, and/or classification of the subsequent input based on the learning without relying on rules-based programming (e.g., conditional statement rules). In this way, the system may change, alter, or reallocate times based on learned user behavior.

The one or more learning model(s) 114 may be or include, for example, one or more: neural networks, Bayesian graphs, Word2Vec word embedding vector models, Random Forests, Gradient Boosting Trees, etc. In an example illustration of how the one or more learning models 114 are utilized to reallocate time, a module may first sample historical data points associated with how long each particular task has taken for a particular meeting that has occurred several times in the past. These data points 114 may then be fed through the one or more learning model(s) 114, at which point patterns may be identified in the sample data points. For example, one pattern may be that a particular meeting historically has taken X minutes, or a particular topic has historically taken only X minutes to discuss, as opposed to the allotted Y quantity of minutes. Accordingly, the learning module(s) 114 may be utilized to make a prediction based on the historical data points in order to re-allocate time among the topics or tasks. For example, using the illustration above, the time adjustment module(s) 112 may adjust the time from Y minutes to X minutes for the particular topic based on a history of only taking that long to finish the particular topic. In another example, a particular group of users may always go over their allotted time by an average of ten minutes for a first topic. Accordingly, if the first topic will be discussed at a future time, the time adjustment module(s) 112 may adjust the time allotted to the first topic by ten minutes based on the group always going over their allotted time by an average of ten minutes.

In some embodiments, the output of the learning model(s) 114 is a score (e.g., a floating point value, where 1 is a 100% match) that indicates the probability that a given input (e.g., a request to set task time) or set of modified features fits within a particular defined class. For example, an input may include initially allocating a task to take 10 minutes. The classification types may be “too much time allocated” and “not enough time allocated.” After this input is fed through each of the layers of the learning module(s) 114, the output may include a floating point value score for each classification type that indicates “too much time allocated: 0.10” and “not enough time allocated: 0.90,” which indicates that there is a 90% probability that the 10 minutes that were initially allocated for the meeting is not going to be enough time based on past inputs being fed into the model. Likewise the 0.10 score indicates that there is a 10% probability that the 10 minutes that were initially allocated for the meeting is too much time allocated. Training or tuning can include minimizing a loss function between the target variable or output (e.g., 0.90) and the expected output (e.g., 100%). Accordingly, it may be desirable to arrive as close to 100% confidence of a particular classification as possible so as to reduce the prediction error. This may happen overtime as more training and baseline data sets are fed into the learning models so that classification can occur with higher prediction probabilities.

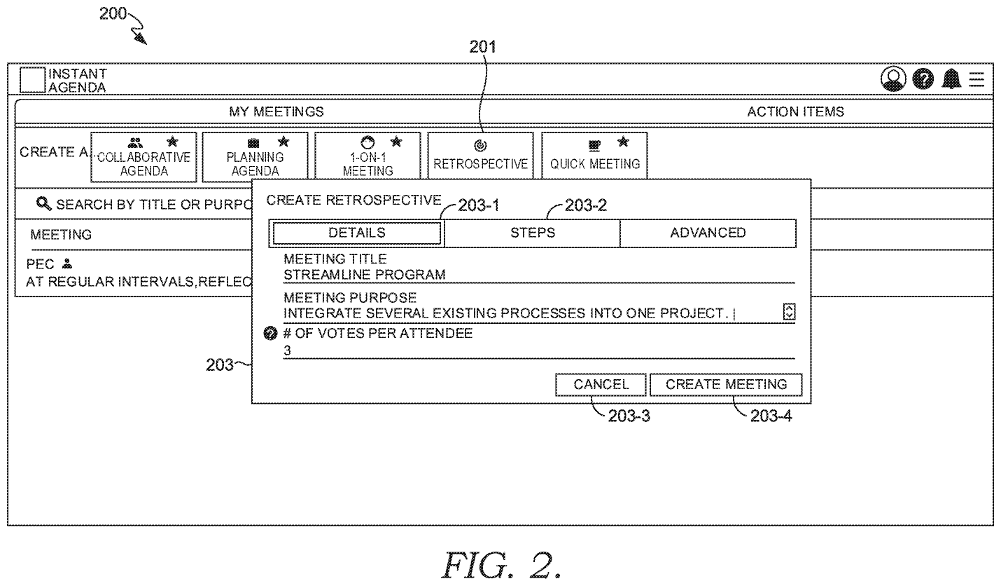

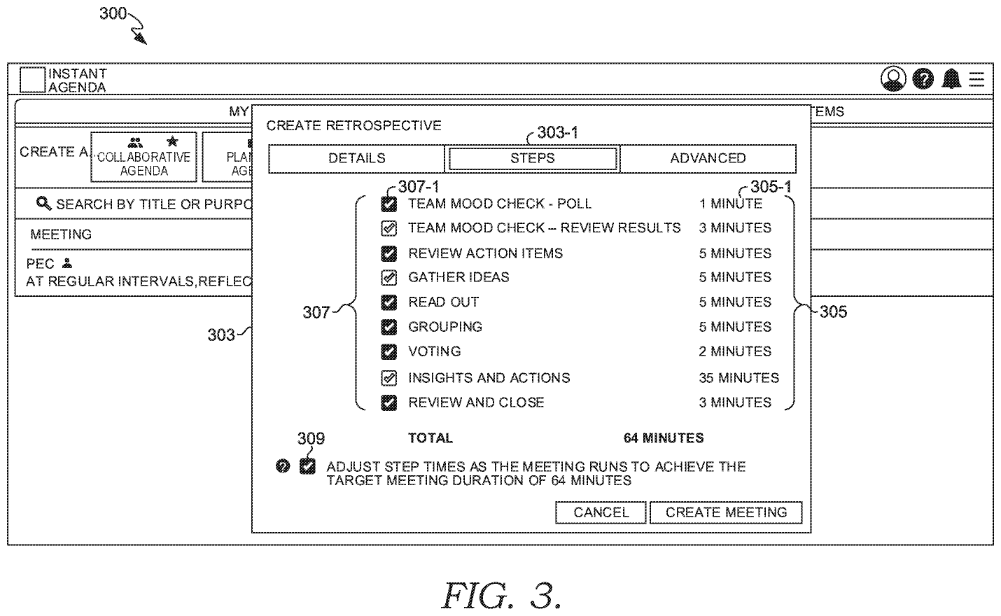

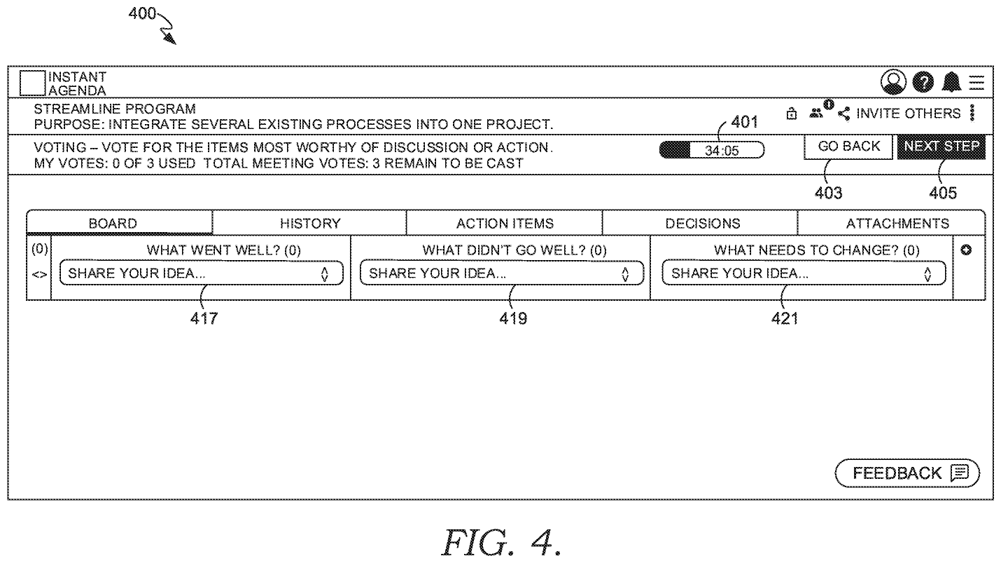

FIG. 2 is a screenshot 200 of an example graphical user interface, according to certain embodiments. The screenshot 200 includes various GUI features associated with a meeting. Although FIGS. 2-4 describe certain aspects associated with a meeting event, it is appreciated that these features can alternatively or additionally be associated with one or more other events, such as a conference, training session, daily workday tasks, schedules, workshops, etc. It is also understood that although the screenshot 200 and the other screenshots of FIGS. 3-4 depict specific GUI features, with specific orientations and information, other features or channels may alternatively or additionally be utilized. For example, a smart device (e.g., a smart speaker) may be configured to recite some or each of the information within the screenshot 200 and a user may issue audible commands (e.g., “select DETAILS”) as user input, as opposed to utilizing visible indicia via a graphical user interface. In another example, a Natural User Interface (NUI) can implement any combination of speech recognition, touch and stylus recognition, facial recognition, biometric recognition, gesture recognition, air gestures, head and eye tracking, and touch recognition associated with displays on a computing device.

The screenshot 200 includes a retrospective button 201. The retrospective button 201 is associated with a team or group of participants where each participant can input information, contribute data to an application workflow, and/or make selections or provide feedback for a meeting, as opposed to only 1 individual (e.g., a manager, supervisor) that dictates all aspects of the meeting. For example, retrospective features may allow each member to input: what went well for a given project, what did not go well in the project, and/or what needs to change within a particular organization or program associated with the project, etc. Other feedback selection may additionally or alternatively include: what meeting will take place (including title), when the meeting will take place, what topics will be discussed, how long the meeting will take, and/or how long each task will take place.

In particular embodiments, in response to a user selection of the button 201, the pop-up window 203 may be displayed, which is indicative of generating a retrospective meeting. The window 203 includes the “details” button 203-1, the “steps” button 203-2, the “cancel” button 203-3, and the “create meeting” button 203-4. In response to a selection (e.g., a user selection) of the details button 203-1, information indicated within the window 203 is displayed, such as “meeting title,” “meeting purpose,” and “# of votes per attendee.” In some embodiments, the user inputs this information under the respective sections. For example, the “meeting title” is “streamline program.” The “meeting purpose” is to “integrate several existing processes into one project.” The number of votes per attendee is set to 3. In response to another selection, such as steps 203-2, a module, such as the metadata extraction module(s) 102 of FIG. 1 may extract some or each of the information within the window 203 in order to process additional steps. In response to a selection of the “steps” button 203-2, one or more topics or tasks and/or time allocations associated with the topics or tasks may be set, which is discussed in more detail below.

The “cancel” button 203-3 allows a user to cancel a meeting in order to refrain from generating additional steps associated with the retrospective meeting. In response to a selection of the “create meeting” button 203-4, a meeting is generated or started (and associated timers). In some embodiments, in response to the selection of the “create meeting” button 203-4, the event generation module(s) 108 of FIG. 1 generates a meeting, as described above.

FIG. 3 is a screenshot 300 of an example graphical user interface, according to certain embodiments. In some embodiments, the window 303 is displayed in response to a user selection of the “steps” button 203-2 of FIG. 2. In some embodiments, the window 303 is displayed in response to a selection of the “steps” button 303-1 of FIG. 3. In particular embodiments, in response to the selection of the “steps” button 303, functions associated with the steps indicator module(s) 104 are computed. The window 303 includes a set of topic or task identifiers 307 that are selected to be completed for a meeting, a set of time identifiers 305 allocated for a particular topic or task, and a field 309 that is selectable in order to adjust individual task times (e.g., via the time adjustment module(s) 112) in order to achieve the target meeting duration of 64 minutes.

The window 303 indicates a plurality of topics or task identifiers 307 that are scheduled to be discussed or addressed in the meeting. For example, the first task that needs to occur is the “team mood check—poll.” 307-1, which is scheduled to take “1 minute,” according to the identifier 305-1. In some embodiments, a user (e.g., a facilitator, moderator, administrator, etc.) may select a field (e.g., indicated by the checkmark) associated with a predefined task/topic in order to identify what topics or tasks will be included in the meeting. In alternative embodiments, the user can manually enter in tasks to the list 307, such that they are not predefined. In various embodiments, the time fields 305 are selectable in order to adjust the quantity of time each topic or task is scheduled to take. For example, the user can manually input “1 minute” into the field 305-1 to set a time allocation for the “team mood check—poll” topic 307-1. In some embodiments, the time set module(s) 106 set their responsive times in response to user selections of the times within the time fields 305. In some embodiments, the system sets each time allocation at a particular default time.

In some embodiments, the time identifiers 305 and/or the topic identifiers 307 are each set only by a moderator via user input on a user device. A “moderator” in particular embodiments is a participant of a plurality of participants of a meeting that is responsible for the content of the meeting. Accordingly, no other participant of the plurality of participants can perform this input in these particular embodiments.

In particular embodiments, in response to a selection of the field 309, the time adjustment module 112 is activated such that remaining times allocated to particular tasks/topics are adjusted in response to finishing before or after a time allotment for one of the topics or tasks. Accordingly, in some embodiments, when the field 309 is not selected, no time is ever adjusted or modified even if a particular topic or task goes over the allotted time during its address or discussion.

FIG. 4 is a screenshot 400 of an example graphical user interface, according to certain embodiments. In some embodiments, the screenshot 400 is displayed in response to a user selection of the “create meeting” button 203-1 of FIG. 2 (and/or the “create meeting” button of FIG. 3). Accordingly in response to this selection, in particular embodiments a counter or timer (e.g., the timer 401) associated with the time set module(s) 106 may be started or initiated. Additionally, indicia associated with the first step (e.g., “team mood check—poll”) may be displayed. This may allow particular users to input various information based on the step or task they are currently engaging in. For example, the field 417 may be configured to receive input from a user on “what went well” for an existing process or program. Likewise, the field 419 may be configured to receive input from a user on “what didn't go well” about the existing program. Likewise, a user may input into the field 421, “what needs to change” about the existing program. In various embodiments, the system 100 (e.g., via the one or more learning models 114) may utilize user input to make adjustments, such as to time. For example, they system 100 may receive user input of “these meetings are too long,” and utilize natural language processing (NLP) methods to identify and process the text, and reduce time via the time adjustment module(s) 112. NLP is a technique configured to analyze semantic and syntactic content of the unstructured data of a set of data. In certain embodiments, the natural language processing technique may be a software tool, widget, or other program configured to determine meaning behind the unstructured data. More particularly, the natural language processing technique can be configured to parse a semantic feature and a syntactic feature of the unstructured data. The natural language processing technique can be configured to recognize keywords, contextual information, and metadata tags associated with one or more portions of the set of data. In certain embodiments, the natural language processing technique can be configured to analyze summary information, keywords, figure captions, or text descriptions included in the set of data, and use syntactic and semantic elements present in this information to identify information used for dynamic user interfaces. The syntactic and semantic elements can include information such as word frequency, word meanings, text font, italics, hyperlinks, proper names, noun phrases, parts-of-speech, or the context of surrounding words. Other syntactic and semantic elements are also possible. Based on the analyzed metadata, contextual information, syntactic and semantic elements, and other data, the natural language processing technique can be configured to make recommendations (e.g., adjust time via the time adjustment module(s) 110).

The “next step” button 405 is selectable to cause a different view to be displayed, which is indicative of a request to switch or skip topics/tasks or go to the next topic/task. For example, referring back to FIG. 3, while a group of users are engaged in the “team mood check—poll” task, the group may be stuck (or finished) on a certain aspect of the task. Responsively, a user may select the “next step” button 405. In response to this selection, the timer 401 is paused in some embodiments and a second identical graphical user interface is displayed associated with the “team mood check—review results” topic, except that the timer is specific to the time allocated (or re-allocated) and the displayed indicia is specific to the “team mood check—review results” topic. The “go back” button 403 is selectable to switch views of the graphical user interface to go “back” to a topic/or task. For example using the illustration above, after or during discussion of the task/topic of “team mood check—review results,” the user may select the “go back button” on that graphical user interface page, in order to arrive at the screenshot 400, which is associated with the “team mood check—poll” topic. Accordingly, in response to the selection of the “go back button,” the timer 401 may resume counting down (or up) time where it left off when the user selected the “next step” button 405. In some embodiments, when the “go back” button 403 is selected, the timer 401 is paused, as described above.

As described in more detail below, in various embodiments, the timer 401 is adjusted or modified (e.g., via the time adjustment module(s) 112) in response to a window or other graphical user interface being open outside of a threshold time without selecting the “next step” button 405. This is associated with a particular task or topic being addressed or completed outside of a time threshold (e.g., anytime before or after the initially allotted time set by the time set module(s) 106).

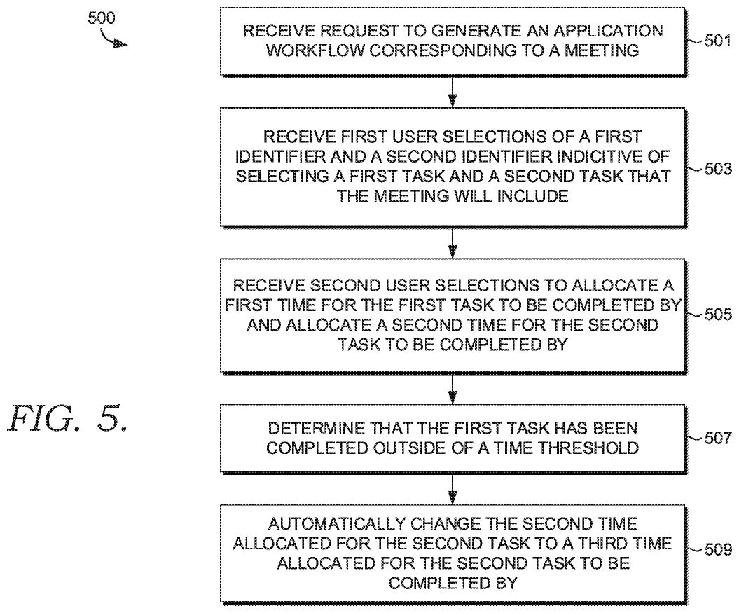

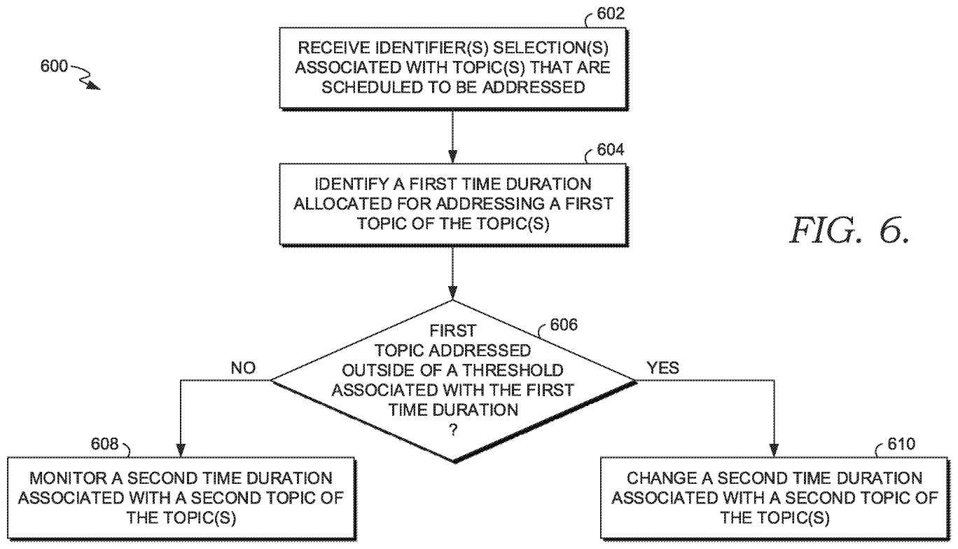

FIG. 5 is a flow diagram of an example process 500 for automatically changing at least a second time allocated for a second task, according to certain embodiments. The process 500 (and/or any processes, e.g., 600 of FIG. 6) may be performed by processing logic that comprises hardware (e.g., circuitry, dedicated logic, programmable logic, microcode, etc.), software (e.g., instructions run on a processor to perform hardware simulation), firmware, or a combination thereof. Although FIG. 5 is described with respect to certain blocks in a particular order, it is understood that one or more of the blocks may not occur, one or more additional blocks may be added, and/or one or more of the existing blocks may occur out of order and/or substantially parallel with other blocks in various embodiments.

Per block 501, a request is received (e.g., by the metadata extraction module(s) 102) to generate an application workflow corresponding to a meeting. An application workflow is a compilation of various components, modules, operations, topics, functions, objects, classes, and/or tasks of a computer program application that make up the application. For a meeting, an application workflow may include the various components of the meeting including any metadata (e.g., topics, initially set time allocations for topics, number of votes per attendee, name of meeting, participants of the meeting, etc.) In some embodiments, users help generate the application workflow, as the system may prompt a user to input various sets of data, such as strings that the system uses to generate an output as executable code in response to the user input. For example, they system may receive the “title” string by the user and responsively displaying the title on a graphical user interface. Accordingly, a user can be responsible for inputting some of these components, such as the title, subject matter, number of votes, etc. associated with the meeting and in response to the input, the system provides an executable output, such as displayed information associated with a meeting. In some embodiments, the system receives the request at block 501 in response to the selection of the retrospective button 201 of FIG. 2. In various embodiments, the application workflow includes a plurality of identifiers (e.g., the identifiers 307) associated with a plurality of tasks that are candidate tasks to be completing during the meeting.

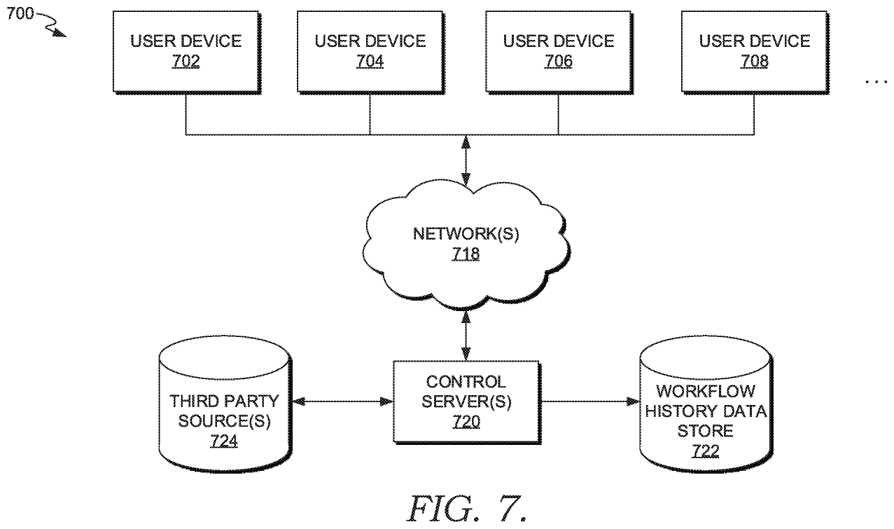

The receiving of the first request at block 501 can occur any suitable manner in various environments. For example, in some embodiments, a user can open a client application, such as a web browser on a user device (e.g., the user device 702), and input a particular Uniform Resource Locator (URL) corresponding to a particular website or portal. In response to receiving the user's URL request, an entity, such as the system 100 may provide or cause to be displayed to the user device, the screenshot 200 as represented in FIG. 2. A “portal” as described herein in some embodiments includes a feature to prompt authentication and/or authorization information (e.g., a username and/or passphrase) such that only particular users (e.g., a corporate group entity) are allowed access to information. A portal can also include user member settings and/or permissions and interactive functionality with other user members of the portal, such as instant chat. In some embodiments a portal is not necessary to provide the screenshot 200 (and/or any of the other screenshots described herein), but rather any of the views can be provided via a public website such that no login is required (e.g., authentication and/or authorization information) and anyone can view the information. In yet other embodiments, the screenshot 200 (and/or any of the screenshots described herein) represents an aspect of a locally stored application, such that a computing device hosts the entire application and consequently the computing device does not have to communicate with other devices (e.g., the control server(s) 720 of FIG. 7) over a network to retrieve data.

Per block 503, first user selections of a first and second identifier are received, which is indicative of selecting a first task and a second task that the meeting will include. For example, referring back to FIG. 3, the identifier 307-1 “team mood check—poll” or an associated field can be selected (e.g., which inputs a checkmark in response to a click within a corresponding field), and the identifier “team mood check—review results” can be selected. In some embodiments, however, more or fewer identifiers can be selected. For example, each of the identifiers 307 can be selected in particular embodiments.

Per block 505, a second set of user selections are received in order to allocate a first time for the first task to be completed by and allocate a second time for the second task to be completed by. For example, referring back to FIG. 3, a user may select or input the string “1 minute” 305-1 indicating that the task 307-1 should only take 1 minute. Additionally, the user may input the string “3 minutes” indicating that the task “team mood check—review results” should only take 3 minutes. In response to these user selections, the system may identify the first time allocated for the first task to be completed by and identify the second time allocated for the second task to be completed by. In some embodiments, the system also identifies a third time allocated for the meeting to be completed by. For example, referring back to FIG. 3, in response to input that the “TOTAL” minutes of the meeting will be 64 minutes, the system may identify this information. In various embodiments, the “TOTAL” minutes or total meeting time is not adjustable. Accordingly, when times are reallocated or changed for particular topics or tasks, the set times of the overall meeting is not exceeded in these embodiments.

Per block 507, it is determined (e.g., via the monitoring module(s) 110) that the first task has been completed outside of a time threshold. A “time threshold” in various embodiments is any suitable time value or range of values. Accordingly, when a current time reading is “outside” of the time threshold, it is a time value or set of values that are not at or within the range of values. Being “outside” of a time threshold can include times that are completed before or after an initial time allocation. For example, time thresholds in various embodiments correspond to the exact time allocated for each of the tasks, as represented by the time identifiers 305 of FIG. 3 (and/or as set by the time set module(s) 106). Accordingly, when topic or task finishes either before or after the exact time allocations, they system determines that the first task has been completed “outside” of a time threshold. In some embodiments, being “outside” of a time threshold corresponds to finishing a task a particular quantity of minutes before (and/or after) initial time allocations. In an example illustration of how this works, with reference to FIG. 4, in response to a user selecting the “create meeting” button 203-4 of FIG. 2, a graphical user interface similar to the screenshot 400 is displayed. The timer 401, in particular embodiments, then begins to count down (or up) in time starting at the time initially allocated for the task. If the screenshot 400 remains open past the time the timer hits 00:00 (i.e., the user has not selected the next step button 405), the monitoring module(s) 110 may then keep track of how long past the time allotted the screen 400 remains open and also notify or call the time adjustment module(s) 112.

Per block 509, the second time allocated for the second task is automatically changed (e.g., via the time adjustment module(s) 112) to a third time allocated for the second task to be completed by. In this way, a user does not have to manually keep track of or pay attention to how much time he or she has left on certain remaining tasks. For example, referring back to FIG. 4, if the user was only allotted 10 minutes for a second task but the screenshot 400 or windows associated with a first task remained open for another 4 minutes exactly, in response to the user selecting the “next step” button 405, the time adjustment module(s) 112 may change or modify the original time allocated (10 minutes) for the second task based at least in part on the determining that the first task has been completed outside of the time threshold. For example, the originally allotted 10 minutes may be reduced. Accordingly, for example, when the user selects the “next step” button 405, an analogous graphical user interface 400 may be displayed on a next screen, which now shows an identical timer to the timer 401 indicating the reduced time allocated for the second task. As described above with respect to the time adjustment module(s) 112, the changing of the second time can be based on one or more rules, which allow the automation of time reallocation tasks. These rules, as described with respect to the time adjustment module(s) 112, can be based on proportion or percentage of time initially allocated for each task, the quantity of remaining tasks still need to be completed, the ranking of tasks, etc.

FIG. 6 is a flow diagram of an example process 600 for changing a time duration for a topic of one or more topics, according to some embodiments. Per block 602, one or more identifier selections are received, which are associated with one or more topics that are scheduled to be addressed. For example, referring back to FIG. 3, the step indicator module(s) 104 may receive the selections of each of the identifiers 307. Per block 604, a first time duration allocated for addressing a first topic of the one or more topics are identified. For example, referring back to FIG. 3, in response to a user inputting or selecting the “1 minute” time duration allocated for the “team mood check—poll,” the system can identify this time duration allocated for addressing this topic.

Per block 606, it is determined whether the first topic has been addressed outside of a threshold associated with the first time duration. For example, referring back to FIGS. 3 and 4, if the window 400 (e.g., associated with the “team mood check—poll” topic) remained open past its initially allocated time duration of 1 minute, it may be determined (e.g., via the monitoring module(s) 110 and/or the time adjustment module(s) 112) that the first topic has been addressed outside of a threshold associated with the first time duration.

Per block 608, if the first topic has not been addressed outside of the threshold associated with the first time duration, then the second time duration associated with a second topic of the one or more topics are monitored. For example, referring back to FIGS. 3 and 4, if the topics “team mood check—poll” ended exactly at (or substantially close to (e.g., within 5 or 10 seconds)) the 1 minute mark (e.g., the user selected the “next step” button 405 at the 1 minute mark), no other adjustments or changes are made to any other topic time allocations, such as the second topic of the one or more topics. Therefore, the second time duration associated with the second topic may be monitored in order to detect if the second time duration is outside of its initially allocated threshold.

Per block 610, if the first topic has been addressed outside of a threshold associated with the first time duration, a second time duration associated with a second topic of the one or more topics are changed or modified (e.g., by the time adjustment module(s) 112 of FIG. 1). For example, if discussion of a topic went 20 minutes over the initially allocated time duration, the 20 minutes can be reduced from other initially allocated time durations from other topics not yet discussed. In some embodiments, machine learning may be utilized to change or reallocate time among topics. For example, prior to receiving a first request (e.g., the request at block 501) to generate an application workflow, the system can receive a second set of requests to generate a second set of application workflows corresponding to a second set of meetings. The system (e.g., the learning model(s) 114) can then identify time completion patterns associated with a set of tasks to be completed for the second set of meetings. The time completing patterns in particular embodiments correspond when an event or task/topic of an event has historically finished. Responsively, in particular embodiments, the automatically changing, altering, or reallocating of times is further based on the identifying of the time completion patterns.

In some embodiments, the changing of the second time duration at bock 610 is based on a remaining quantity of tasks that need to be completed and identifying a duration of each task. For example, it can be determined, subsequent to a first task being completed, a remaining quantity of tasks that need to be completed. The remaining quantity of tasks may correspond to user selected tasks of a plurality of tasks that an event will include. A duration that each task of the remaining quantity of tasks is scheduled to take may be identified. Responsively, the second time duration allocated for a second task can be automatically changed based on the determining of the remaining quantity of tasks that need to be completed and the identifying of the duration of each task, as well as the duration set for the entire meeting (e.g., 64 minutes in FIG. 3). In an example illustration, a meeting may include the following topics and associated initial time allocations: “Review Action Items: 5 minutes” (1^{st} step), “Gather Ideas: 5 minutes” (2^{nd} step), “Grouping: 5 minutes” (3^{rd} step), “Voting: 2 minutes” (4^{th} step), “Insights and Actions: 35 minutes” (5^{th} step), “Review and Close: 3 minutes” (6^{th} step), and “TOTAL: 55 minutes.” If a meeting is running 5 minutes ahead of schedule by the time voting needs to occur (e.g., because the 1^{st} step finished in 4 minutes, the 2^{nd} step finished in 3 minutes, and the 3^{rd} step finished in 3 minutes), it may be identified that the steps 4-6 may still need to occur. Further, more time may be allocated for the rest of the steps based on the proportion of time initially allocated. For example, the 4^{th} step time may be increased from 2:00 to 2:15, the 5^{th} step time may be increased from 35:00 to 39:25, and the 6^{th} step time may be increased from 3:00 to 3:20. Accordingly, the additional time reallocated among the steps adds up to the 5 minutes that were ahead of schedule. The particular time reallocation algorithm in this example may be reallocating more time for longer initially allocated times of particular topics and reallocating less time for shorter initially allocated times associated with the other topics. Accordingly, the 5^{th} step time may be adjusted or changed the most or be reallocated the most time of the remaining topics based on the initially allocated time of 35 minutes (which is 30 minutes longer than the next highest initially allocated time).

In some embodiments, the particular time reallocation algorithm may alternatively or additionally include reallocating less time for longer initially allocated times of particular topics and reallocating more time for shorter initially allocated times associated with the other topics. In some embodiments, more time may be taken away or removed from tasks that were initially allocated more time and less time may be taken away or removed from tasks that were initially allocated less time. This may occur in situations, for example, where instead of being ahead of schedule, an event is running behind schedule. Accordingly, this algorithm may ensure that brief time allocation topics are addressed instead of being drastically reduced or removed altogether. For example using the illustration above, if a meeting was running 25 minutes behind schedule, the 5th step time may be reduced the most (e.g., 5 minute) based on the fact that it has a lot more time allocated to it compared to the rest of the steps.

The exact proportions that time is either added or taken away from initial time allocations may be based on various algorithms or rules, such as proportionality or percentage of initially allocated times in relation to the total allotted times for events. For example, referring to the example above, if a meeting was running 5 minutes ahead of schedule and each of the topics 1-6 were initially allocated the specified times, the system (e.g., the time adjustment module(s) 112) can first identify the proportion or percentage of each task time of the total event time (e.g., 64 minutes in FIG. 3). This may occur by dividing each of the individual task times (e.g., 5^{th} step—35 minutes) by the total event time (e.g., 55 minutes). According to the example above, the following task times makeup corresponding percentages of the overall meeting times—1^{st} step=9%, 2^{nd} step=9%, 3^{rd} step=3.6%, 4^{th} step=9%, 5^{th} step=63.6%, and the 6^{th} step=5.4%. Accordingly, in some embodiments the algorithm adds (and/or removes) time to each of these steps according to the percentage of its makeup of the overall meeting duration. For example, if a meeting was running ahead of schedule by 10 minutes, the 3^{rd} step would be allocated 3.6% of the 10 minutes, the 5^{th} step would be allocated 63.6% of the 10 minutes, etc.

FIG. 7 is a block diagram of a computing environment 700 in which aspects of the present disclosure are employed in, according to certain embodiments. Although the environment 700 illustrates specific components at a specific quantity, it is recognized that more or less components may be included in the computing environment 700. For example, in some embodiments, there is only one user device 702 and none of the user devices 704, 706, and 708 exist.

The user devices 702, 704, 706, and 708 are communicatively coupled to the control server(s) 720, the third party sources 724, and/or the workflow history data store 722 via the one or more networks 718. In practice, the connection may be any viable data transport network, such as, for example, a LAN or WAN. Network(s) 718 can be for example, a local area network (LAN), a wide area network (WAN) such as the Internet, or a combination of the two, and include wired, wireless, or fiber optic connections. In general, network(s) 718 can be any combination of connections and protocols that will support communications between the control server(s) 720 and the user devices

In some embodiments, each of the user devices 702, 704, 706, and 708 correspond or are associated with each member of a group invited to a meeting or other event. For example, in particular embodiments an event or meeting may be a virtual event or meeting such that each participant can view some or each of the screenshots as illustrated in FIGS. 2-4. For example, referring back to FIG. 4, each participant can be prompted to input the information in the fields while the timer 401 is counting down or up. In alternative embodiments, there is only one user device 702 (which include the screenshots of FIGS. 2-4), and each participant of an event is in the same room or in close proximity to a user (e.g., a moderator) that is running the meeting and associated meeting software. In particular embodiments, some or each of the user devices 702, 704, 706, and 708 are configured to display some or each of the screenshots associated with FIGS. 2-4 and receive the associated input (e.g., identifiers 307, 305) as described above.

In some embodiments, the one or more control servers 720 are responsible for reallocating time for one or more tasks or topics. In some embodiments, the one or more control servers 720 include some or each of the modules as described in FIG. 1. In particular embodiments, the one or more control servers 720 is responsible for providing or causing display for some or each of the screenshots as described in FIGS. 2-4. The workflow history data store 722 in some embodiments is a database that includes a history of past events (e.g., application workflows) so that one or more learning models (e.g., the learning model(s) 114) can be fed data points, identify one or more patterns in the data points, and make predictions for learned user behavior. Learned user behavior can include identifying a history of time sequences indicating how long a plurality of tasks took to complete for pasts events, predicting based on the time sequences, and modifying initially allocated times. For example, in response to identifying that a user created 10 past meetings, as located in the workflow history data store 722, these 10 past meetings or associated data points can be fed through a learning model to identify that a group of users for a particular meeting always went 10 minutes over the initially allotted time. Responsively, the system can predict that the same such meeting will also go 10 minutes over. In response to this prediction, the system in particular embodiments automatically adjusts or changes the initially allocated time to incorporate 10 more minutes.

The one or more third party sources 724 are associated with other systems or services outside of the control server(s) 720. In some embodiments, the data within the third party sources(s) 724 are used as data points to be fed through the one or more learning model(s) 114. For example, in some embodiments, the third party source(s) 724 includes one or more social media services, weather services, mobile data services, websites, news services, blogs, etc. Accordingly, for example, the one or more control servers 720 in various instances include interfaces that are configured to communicate over a network (e.g., the internet) with other service's APIs, such that the control server(s) 720 may obtain relevant data for learning purposes. For example, in some instances, a user may use additional applications for generating application workflows for meetings. In these instances, these application workflows can be synchronized with the application workflows described herein. In another example, third party sources may additionally or alternatively indicate that a person or group of persons may take longer or shorter on a certain task/topic item. In For example, a social media account of each person in a meeting may indicate that each person strongly values a particular topic (e.g., voting, machine learning software, risk hedging practices, etc.). Accordingly, after querying these APIs to get this information, it may be fed through a learning model to identify this and one or more times or durations associated with particular topics may be adjusted based on the affinities or values of particular topics.

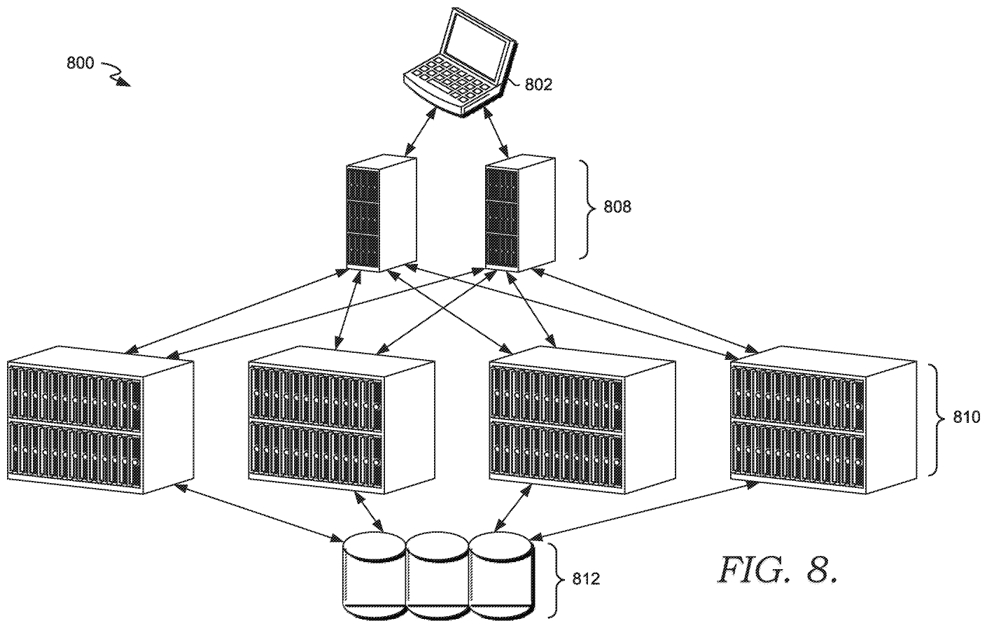

FIG. 8 is a schematic diagram of a computing environment 800, according to embodiments. In some embodiments, the computing environment 800 illustrates the physical layer schema of different hosts that implement the processes and actions described herein. In some embodiments, the computing environment 800 can be included in the computing environment 700 or be the computing environment 700's physical layer implementation.

The computing environment includes the user device 802, the first tier hosts 808, the middle tier hosts 810, and the third tier hosts 812. The first tier hosts 808 can be or include any suitable servers, such as web servers (i.e., HTTP servers). Web servers are programs that use Hypertext Transfer Protocol (HTTP) to serve files that form web pages to the user device 802 in response to requests from HTTP clients (e.g., a browser) stored on the user device 802. Web servers are typically responsible for front-end web browser-based GUIs at the user device 802. The web server can pass the request to a web server plug-in, which examines the URL, verifies a list of host name aliases from which it will accept traffic, and chooses a server to handle the request

The middle tier hosts 810 can be or include any suitable servers, such as web application servers (e.g., WEBSPHERE application servers). Accordingly, a web container within the middle tier hosts 810 can receive the forwarded request from one or more of the first tier hosts 808 and based on the URL dispatch to the proper application (e.g., a pagelet, plurality of web page views). A web application server is a program in a distributed network that provides business logic for an application program. In some embodiments, the middle tier hosts 810 include some or all of the system architecture 100 of FIG. 1, such as the time set module(s) 106, the time adjustment module(s) 112, etc. In some embodiments, the middle tier hosts 810 include third party or vendor-supplied business logic.

The third tier hosts 812 can be or include any suitable servers, data stores, and/or data sources such as databases. In some embodiments, the third tier hosts 812 include some or each of the data supplied to user device, such as the workflow history data store 722 of FIG. 7. In some embodiments, the third tier hosts include third party or vendor application data repositories, such as the third party source(s) 724 of FIG. 7.

All three tiers of hosts illustrate how a user requests data and an application and/or user interface is rendered. The presentation of the GUI at the user device 802 can be implemented via the first tier hosts 808, which include the business logic rendered by the middle tier hosts 810 and the data and/or views residing within the third tier hosts 812. Together, the business logic and the data can form an application (e.g., a pagelet) as utilized by the first tier hosts 808 for presentation of the GUI within a web page or other application. For example, the screenshot GUIs with respect to FIGS. 2-4 are rendered based on the functionalities of the first, second, and third tier hosts in particular embodiments.

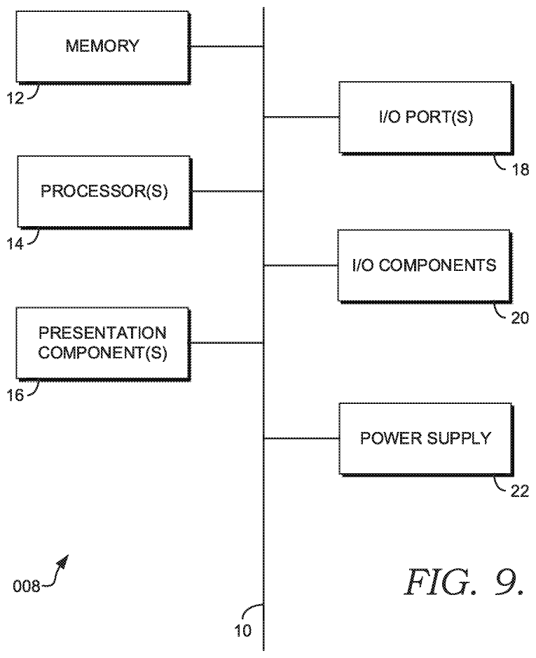

With reference to FIG. 9, computing device 008 includes bus 10 that directly or indirectly couples the following devices: memory 12, one or more processors 14, one or more presentation components 16, input/output (I/O) ports 18, input/output components 20, and illustrative power supply 22. Bus 10 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that this diagram is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 9 and reference to “computing device.”

In some embodiments, the computing device 008 represents the physical embodiments of one or more systems and/or components described above. For example, the computing device 008 can be the user device(s) 702, 704, 706, 708, 802, and/or the control server(s) 720. The computing device 008 can also perform some or each of the blocks in the processes 500 and 600. It is understood that the computing device 008 is not to be construed necessarily as a generic computer that performs generic functions. Rather, the computing device 008 in some embodiments is a particular machine or special-purpose computer. For example, in some embodiments, the computing device 008 is or includes: a multi-user mainframe computer system, a single-user system, a symmetric multiprocessor system (SMP), or a server computer or similar device that has little or no direct user interface, but receives requests from other computer systems (clients), a desktop computer, portable computer, laptop or notebook computer, tablet computer, pocket computer, telephone, smart phone, smart watch, or any other suitable type of electronic device.

Computing device 008 typically includes a variety of computer-readable media. Computer-readable media can be any available media that can be accessed by computing device 008 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 008. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 12 includes computer storage media in the form of volatile and/or nonvolatile memory. The memory may be removable, non-removable, or a combination thereof. Exemplary hardware devices include solid-state memory, hard drives, optical-disc drives, etc. Computing device 008 includes one or more processors 14 that read data from various entities such as memory 12 or I/O components 20. Presentation component(s) 16 present data indications to a user or other device. Exemplary presentation components include a display device, speaker, printing component, vibrating component, etc.

I/O ports 18 allow computing device 008 to be logically coupled to other devices including I/O components 20, some of which may be built in. Illustrative components include a microphone, joystick, game pad, satellite dish, scanner, printer, wireless device, etc. The I/O components 20 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 008. The computing device 008 may be equipped with depth cameras, such as, stereoscopic camera systems, infrared camera systems, RGB camera systems, and combinations of these for gesture detection and recognition. Additionally, the computing device 008 may be equipped with accelerometers or gyroscopes that enable detection of motion.

The present disclosure may include a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Definitions

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “data store” as described herein is any type of repository for storing and/or managing data, whether the data is structured, unstructured, or semi-structured. For example, a data store can be or include one or more: databases, files (e.g., of unstructured data), corpuses, digital documents, etc.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

The terms first (e.g., first cache), second (e.g., second cache), etc. are not to be construed as denoting or implying order or time sequences unless expressly indicated otherwise. Rather, they are to be construed as distinguishing two or more elements. In some embodiments, the two or more elements, although distinguishable, have the same makeup. For example, a first memory and a second memory may indeed be two separate memories but they both may be RAM devices that have the same storage capacity (e.g., 4 GB).

The term “causing” or “cause” means that one or more systems (e.g., computing devices) and/or components (e.g., processors) may in in isolation or in combination with other systems and/or components bring about or help bring about a particular result or effect. For example, a server computing device may “cause” a message to be displayed to a user device (e.g., via transmitting a message to the user device) and/or the same user device may “cause” the same message to be displayed (e.g., via a processor that executes instructions and data in a display memory of the user device). Accordingly, one or both systems may in isolation or together “cause” the effect of displaying a message.

The term “computing system” means a single computing device (e.g., a mobile device) and/or multiple computing devices (e.g., multiple cloud computing nodes).

A “computing device” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

A “session” can be initiated when a user logs into a site, or is recognized by the site as returning user who is associated with activity on the site. For example, a site may recognize a returning user via cookies. A session can be considered terminated after a user logs off of a site or becomes inactive (or idle) on the site for a predetermined period of time. For example, after 30 minutes of idle time without user input (i.e., not receiving any queries or clicks), the system may automatically end a session.

“Automatically” means “without any human intervention.”

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

What is claimed is:

1. A computer-implemented method comprising:
receiving a first request to generate an application workflow corresponding to a meeting, the application workflow includes a plurality of identifiers associated with a plurality of tasks that are candidate tasks to be completed during the meeting;
receiving user selections of a first identifier and a second identifier of the plurality of identifiers, the user selections indicative of selecting a first task and a second task of the plurality of tasks that the meeting will include;
identifying a first time allocated for the first task to be completed by, identifying a second time allocated for the second task to be completed by, and identifying a third time allocated for the meeting to be completed by;
determining that the first task has been completed outside of a time threshold associated with the first time allocated for the first task to be completed by; and
based at least in part on the determining that the first task has been completed outside of the time threshold, automatically changing the second time allocated for the second task to a fourth time allocated for the second task to be completed by.

2. The method of claim 1, further comprising:
receiving, prior to the receiving of the request to generate an application workflow, a second set of requests to generate a second set of application workflows corresponding to a second set of meetings; and
identifying time completion patterns associated with a set of tasks to be completed for the second set of meetings; and
wherein the automatically changing of the second time to the fourth time is further based on the identifying time completion patterns.

3. The method of claim 1, further comprising:
determining, subsequent to the first task being completed, a remaining quantity of tasks that need to be completed, the remaining quantity of tasks corresponding to user selected tasks of the plurality of tasks that the meeting will include;
identifying a duration that each task of the remaining quantity of tasks is scheduled to take; and
wherein the automatically changing the second time allocated for the second task to a fourth time allocated for the second task to be completed by is further based on the determining of the remaining quantity of tasks that need to be completed and the identifying of the duration of each task.

4. The method of claim 1, further comprising:
identifying a third set of times allocated for a third set of tasks, of the plurality of tasks, to be completed by; and
in response to determining that the first task has been completed outside of the time threshold, changing each of the third set of times to a fourth set of times, wherein the changing of each of the third set of times to the fourth set of times does not exceed the third time allocated for the meeting to be completed by.

5. The method of claim 1, wherein the meeting is associated with one or more participants, each participant of the one or more participants being able to contribute data to the application workflow.

6. The method of claim 1, wherein the first time, the second time, and the third time are each set via user input on a user device, wherein the user input is implemented by a moderator that is one participant of a plurality of participants of the meeting, and wherein no other participant of the plurality of participants can perform the user input.

7. The method of claim 1, wherein the determining that the first task has been completed outside of a time threshold corresponds to determining that the first task has been completed a particular quantity of minutes before the first time allocated, the method further comprising reallocating a portion of the particular quantity of minutes to the second task such that the second task is scheduled to be completed by the fourth time, the fourth time being longer in duration than the second time.

8. A system comprising:
at least one computing device having at least one processor; and
at least one computer readable storage medium having program instructions embodied therewith, the program instructions readable or executable by the at least one processor to cause the system to:
identify a plurality of identifiers associated with a plurality of topics that are scheduled to be addressed;
identify a first time duration allocated for addressing a first topic of the plurality of topics to be addressed within;
determine whether the first topic has been addressed outside of a threshold associated with the first time duration; and
in response to the determining that the first topic has been addressed outside of the threshold, change at least a second time duration allocated for at least a second topic of the plurality of topics.

9. The system of claim 8, wherein the plurality of topics are included in an event of a group of events consisting of: a meeting, a training session, a conference, a workshop, and a schedule.

10. The system of claim 8, wherein the program instructions further cause the system to:
identify, prior to the determining whether the first topic has been addressed outside of a threshold, time completion patterns associated with past user behavior for past meeting events; and
wherein the changing of the second time is further based on the identifying time completion patterns.

11. The system of claim 8, wherein the program instructions further cause the system to:
determine, subsequent to the first topic being addressed, a remaining quantity of topics that need to be addressed;
identifying a duration that each topic of the remaining quantity of topics is scheduled to be addressed for; and
wherein the changing the second time is further based on the determining of that a first quantity of topics still need to be addressed, and wherein the changing the second time duration includes adding a higher proportion of time to a first set of durations that are over a duration threshold, and adding a lower proportion of time to a second set of durations that are not over the duration threshold.

12. The system of claim 8, wherein the first time duration is set via user input on a user device, wherein the user input is implemented by a moderator that is one participant of a plurality of participants of a meeting.

13. The system of claim 8, wherein the determining whether the first topic has been addressed outside of a threshold of the first time duration corresponds to determining that the first topic has been addressed for a particular quantity of minutes before the first time duration ends, the method further comprising reallocating a portion of the particular quantity of minutes to the second topic such that the second topic is scheduled to be completed by a fourth time, the fourth time being longer in duration than the second time duration.

14. The system of claim 8, wherein the program instructions further cause the system to:
receive a first user request to skip the second topic to address another topic;
in response to the receiving of the first user request, pause a timer associated with the first topic;
receive a second user request to go back to the second topic; and
in response to the receiving of the second user request, resume the timer associated with the second topic.

15. A computer program product comprising a computer readable storage medium having program instructions embodied therewith, the program instructions are readable or executable by at least one processor to cause the at least one processor to:
identify one or more identifiers associated with one or more topics that are scheduled to be addressed within an event;
identify a first time duration allocated for addressing a first topic of the one or more topics;
monitoring the event to determine whether the first topic has been addressed outside of a threshold of the first time duration; and
modify, based at least in part on the determining that the first topic has been addressed outside of the threshold and based further on learned user behavior, a second time associated with the event.

16. The computer program product of claim 15, wherein the first topic is included in an event of a group of events consisting of: a training session, a conference, and a workshop.

17. The computer program product of claim 15, wherein the learned user behavior includes identifying a history of time sequences indicating how long a plurality of tasks took to complete for past meetings associated with the event.

18. The computer program product of claim 15, wherein the one or more topics are included in a set of topics that are selectable to be addressed, and wherein each topic of the set of topics is associated with a time duration allocated for addressing the each topic, and wherein the time duration is adjustable by a user.

19. The computer program product of claim 15, wherein the monitoring of the event and the changing of the second time occurs in response to a user selection of a feature on a graphical user interface, and wherein when the feature is not selected, the second time is not changed.

20. The computer program product of claim 15, wherein the event corresponds to a meeting that is associated with one or more participants, each participant of the one or more participants being able to contribute data to a workflow application, and wherein the contributing of data corresponds to receiving participant feedback from the one or more participant regarding the one or more topics.
